(19) United States
(12) Patent Application Publication
(10) Pub. No.: US 2015/0160951 A1
(43) Pub. Date: Jun. 11, 2015

(54) REMOTE LAUNCH OF APPLICATION ON MOBILE DEVICE

(71) Applicant: Madurai Sriram Iyengar, Houston, TX (US)

(72) Inventor: Madurai Sriram Iyengar, Houston, TX (US)

(73) Assignee: BOARD OF REGENTS OF THE UNIVERSITY OF TEXAS SYSTEM, Austin, TX (US)

(21) Appl. No.: 14/562,130

(22) Filed: Dec. 5, 2014

Related U.S. Application Data
(60) Provisional application No. 61/912,694, filed on Dec. 6, 2013.

(51) Int. Cl. G06F 9/44; G06F 9/445; H04L 29/08

(52) U.S. Cl. CPC G06F 9/4446; H04L 67/025; G06F 8/60

(57) ABSTRACT

A system allows remotely launching an application on a remote device. The application uses a guided document to provide instructional or procedural information to a user of the mobile device. An administrator of the system may define one-time or recurring events that will cause the remote system to instruct the mobile device to launch the application with the guided document.

### TECHNICAL FIELD

The present invention relates to the field of instructional software, and in particular to a technique for remotely launching an instructional software application on a mobile device.

### BACKGROUND ART

Instructional software applications have been popular for many years. With the advent of mobile devices such as tablets and smart phones, software developers have provided platforms for the development and deployment of instructional software applications for use on such mobile devices. However, developers of these instructional software applications have had to depend upon the user of the mobile device to decide to run the instructional software application. A way to provide more centralized control over when these mobile instructional software applications execute would provide numerous benefits and improvements over the current technology.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIGS. 1-7 are screenshots illustrating screens of a user interface for scheduling launch of a guided instructional software application according to one embodiment.

FIGS. 8-9 are illustrations of a mobile device illustrating an installed guided instructional software application according to one embodiment.

FIG. 10 is a flowchart illustrating a technique for remotely scheduling a launch of the guided instructional software application of FIGS. 1-9 according to one embodiment.

FIGS. 11-20 are illustrations of screens of an application for displaying a guided document according to one embodiment.

FIGS. 21-22 are illustrations of screens of an administrative application for creating guided instruction documents according to one embodiment.

FIG. 23 is a block diagram illustrating a system of a server and mobile devices for scheduling on the server to launch guided documents on the mobile devices according to one embodiment.

FIG. 24 is a block diagram of a programmable device that can be used for a scheduling server or mobile device according to one embodiment.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts are understood to reference all instance of subscripts corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

Although some of the following description is written in terms that relate to software or firmware, embodiments can implement the features and functionality described herein in software, firmware, or hardware as desired, including any combination of software, firmware, and hardware. References to daemons, drivers, engines, modules, or routines should not be considered as suggesting a limitation of the embodiment to any type of implementation.

Instructional software applications as disclosed herein can be used to support healthcare and other needs, providing users with guided instructional software that can be executed, for example, but not limited to, on a patient's or a clinic-provided mobile device to guide the patient or a patient's caregiver through remedial or recovery procedures. Although referred to generally herein as instructional, the software application is not limited to purely instructional uses, but may be used for provide guided ‘how-to’ procedure instructions, knowledge, and learning of all kinds, from Art to Zoology. The software applications may be used in areas other than healthcare. For example, in commercial and industrial settings, the software may be used for guiding a worker through safety procedures or maintenance checklists; in healthcare settings, the software may be used for guiding a healthcare worker through diagnostic or treatment procedures without the need for a trained physician on-site; in manned spaceflight, the software may be used for guiding astronauts through procedures or checklists for everything from spacecraft operations to astronaut healthcare. Many other uses can be contemplated.

In one embodiment, the instructional software application may be provided as an application for execution by a mobile device, which may be a user-owned mobile device. The application may make use of text, images, video, and audio in one or more languages, or any combination thereof, providing a multimedia user experience. An application developer may use an authoring system provided by a vendor of the software system that allows decision trees to be designed using a graphical user interface, then save the application in a form for downloading to the mobile device. In one embodiment, the authoring system may allow saving the application in multiple formats, allowing generating the application for use in mobile devices from different manufacturer and running different mobile device operating systems.

The instructional software application may be configured to execute without external connectivity, so the application may be usable in areas without mobile Internet or phone connectivity. However, applications may be created using the instructional software authoring system that make use of Internet or phone capability for any desired use, such as reporting results back to a central location.

Remote launching in one embodiment may be performed on a scheduled basis without external connectivity at the time of the event, by loading the launch schedule into a scheduler executing on the mobile device at a time when the mobile device has sufficient connectivity to download the schedule, the software, or both. Preferably, however, the scheduling of remote launch of the software is performed on a central server, such as a remote website, which then instructs the mobile devices to launch the instructional software according to the schedule. Ad hoc, on-demand, remote launching may also be provided for, but requires external connectivity at the time of the remote launching.

In one embodiment, in addition to scheduled launch of the application, a user with administrator privileges can send a message from the remote website to a particular user's mobile device to launch a specific instance of the application on the mobile device. In another embodiment, the user may send a message from the remote website to a plurality of users' mobile devices to launch an instance of the application on each of their mobile devices.

Such a feature is very useful, for example, to support compliance to treatment or medication regimens in multiple areas, including adherence to treatment guidelines. For example, patients discharged after surgery can be prompted remotely with multi-media instructions at specific times and days to perform wound care, rehabilitation exercises, etc.

In various embodiments, information is presented interactively, step-by-step, accompanied by rich media (audio, voice, image, video and text), from special guided documents, which can be downloaded from a central server through the application or by connection to a storage device, such as a USB storage device. Although some applications may not need or use connectivity to play the special guided documents on the user's device, applications may also be communications-enabled and location-aware. For example, a mobile smart phone instance of the application may be configured to call, send an SMS or email based on contact information provided in the guide document. A single mobile device may have a single copy of the software application, but be capable of processing multiple guided documents for different instructional or other purposes.

In one embodiment, the guided documents are created using a point-and-click interface, without any programming or coding, using an authoring software. Voice, text, images, videos and animations can be integrated into the guide document by dragging and dropping. In one embodiment the authoring tool is programmed for use on an individual user's computer, such as a personal computer.

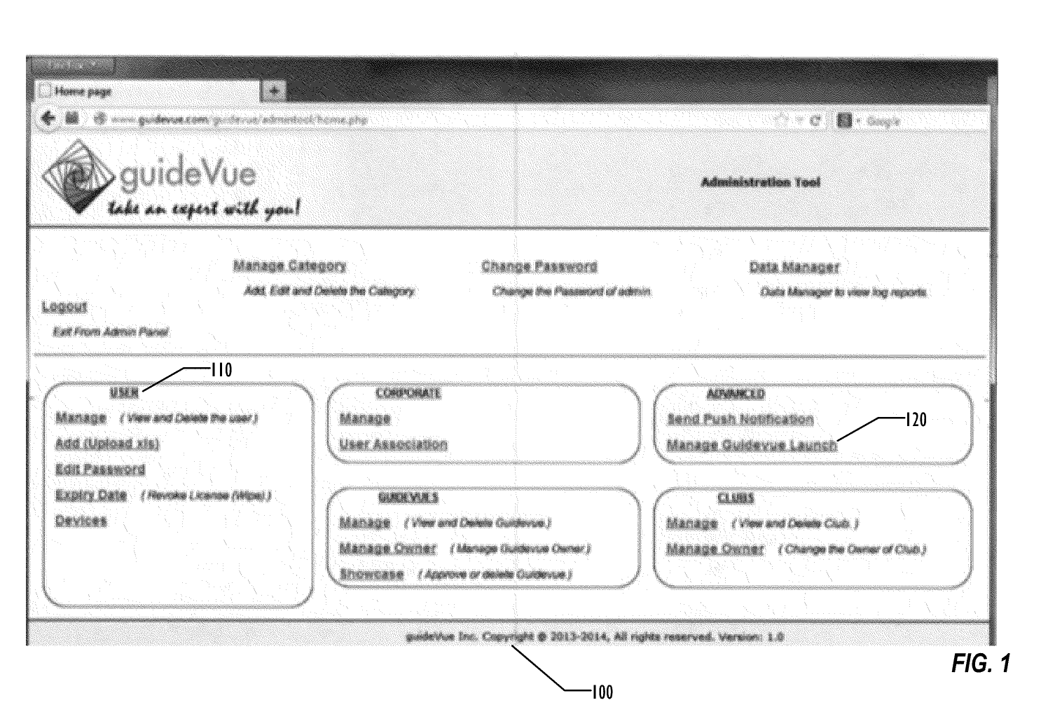

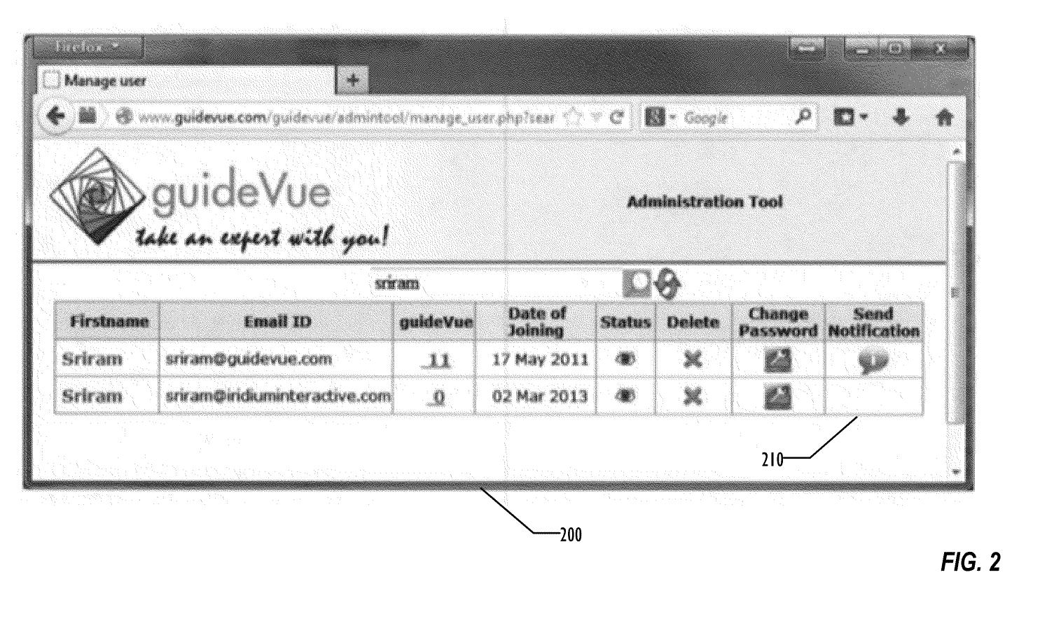

FIGS. 1-7 are screenshots illustrating defining a schedule for launching a guided document on a mobile device according to one embodiment. In the embodiments illustrated in the Figures, a guided document is referred to as a “Guidevue,” which is a trademark of guideVue, Inc. An administrative user of the system enters the scheduling system using the administration tool 100 illustrated in FIG. 1. Various functionality may be provided by the administration tool, including user management functionality 110 and management of guided documents 120. FIG. 2 illustrates an example screenshot 200 of a user management screen, indicating a list of users with devices enabled for remote activation. In some embodiments, some mobile devices may be enabled for remote activation by launching a guided document remotely, while other mobile devices may be disabled for remote activation. In the example of FIG. 2, enablement for remote activation is indicated in the column 210 labelled “Send Notification.”

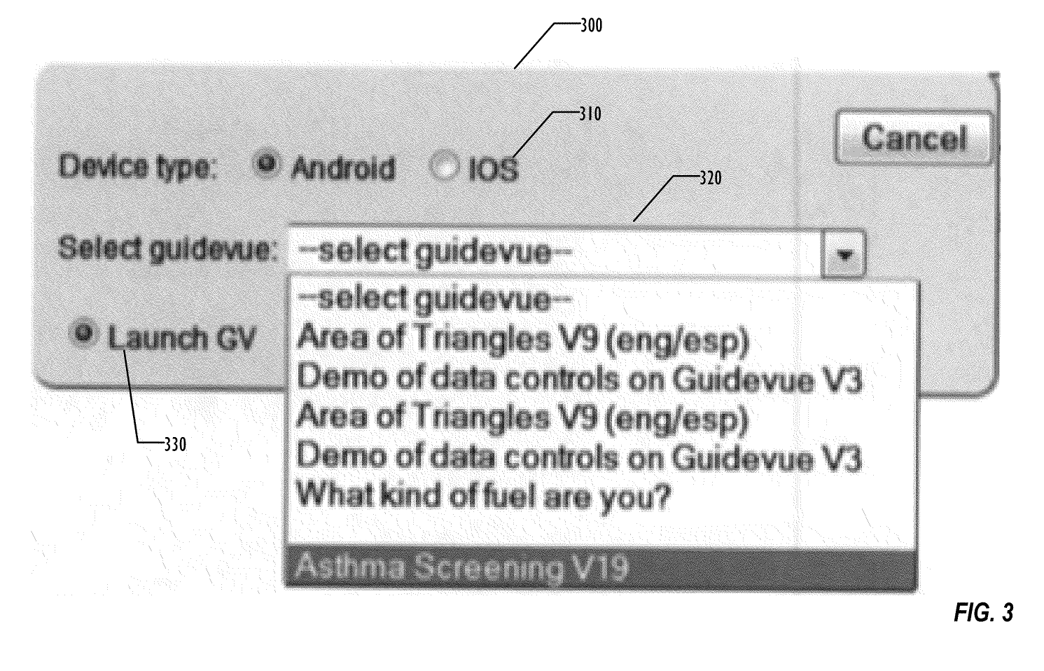

FIG. 3 is a screenshot of management of guided documents that may be obtained through the management interface 120 of the administration tool 100. In this example, the operating system of the mobile device on which a guided document is to be launched may be selected using control 310. The guided document to be launched may be selected in control 320. Control 330 allows the administrative use to schedule an immediate launch of the guided document.

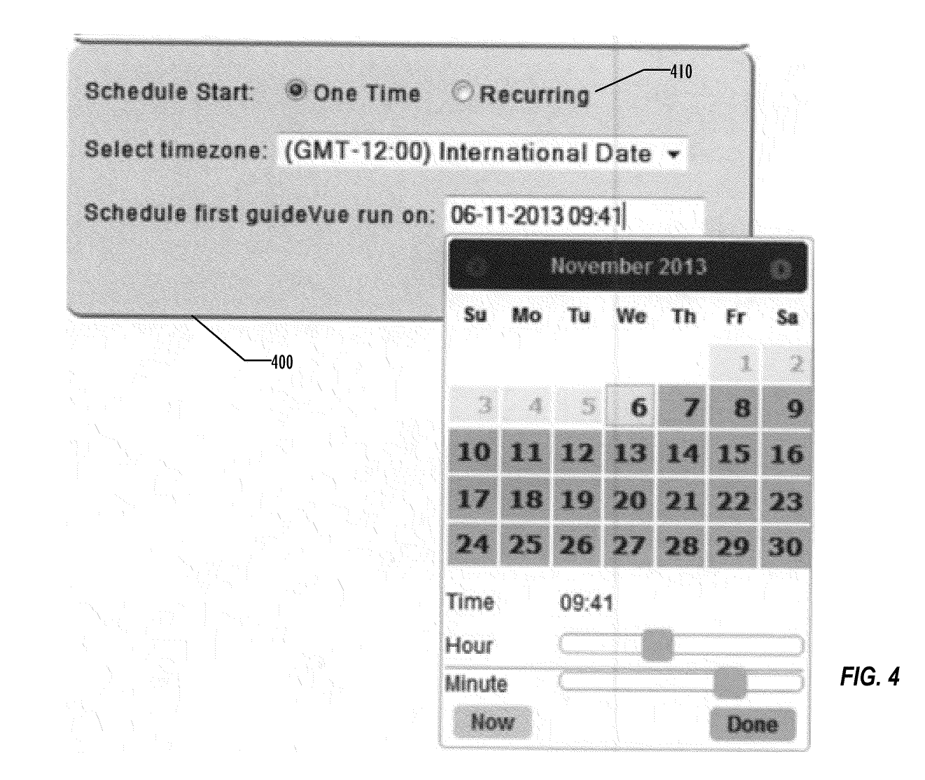

FIG. 4 is a screenshot of a user interface 400 for scheduling launch of a guided document remotely according to one embodiment. As indicated by control 410, the scheduling may be for a one time launch or a recurring launch of the guided document. Other controls of user interface 400 may specify the time and date of the initial launch of the guided document. The specific controls illustrated in FIG. 4 are illustrative and by way of example only, and any user interface control elements for specifying date and time information may be used as desired, in any arrangement.

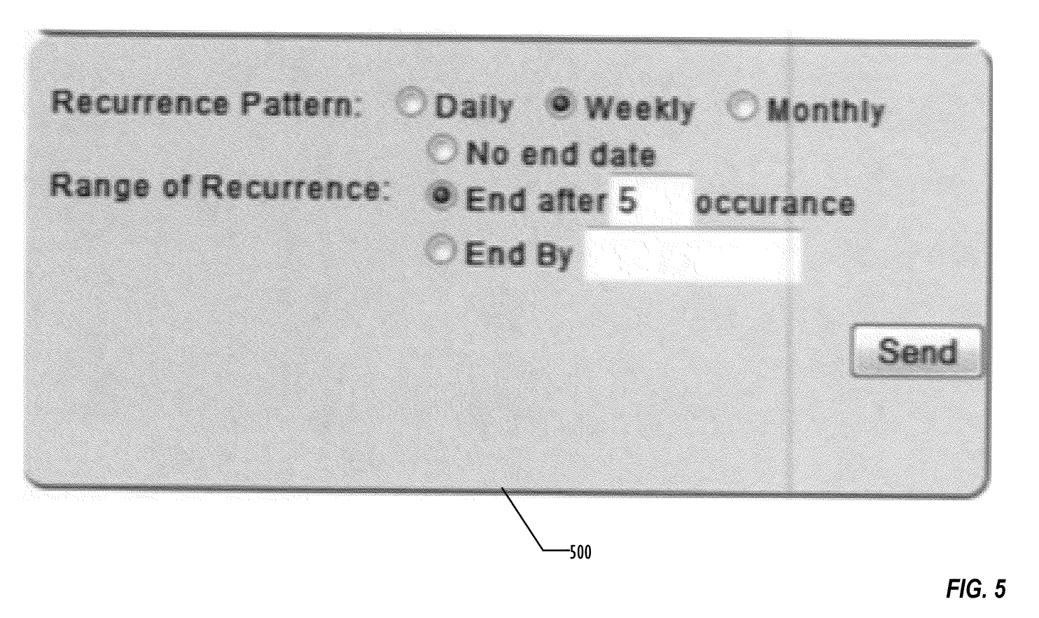

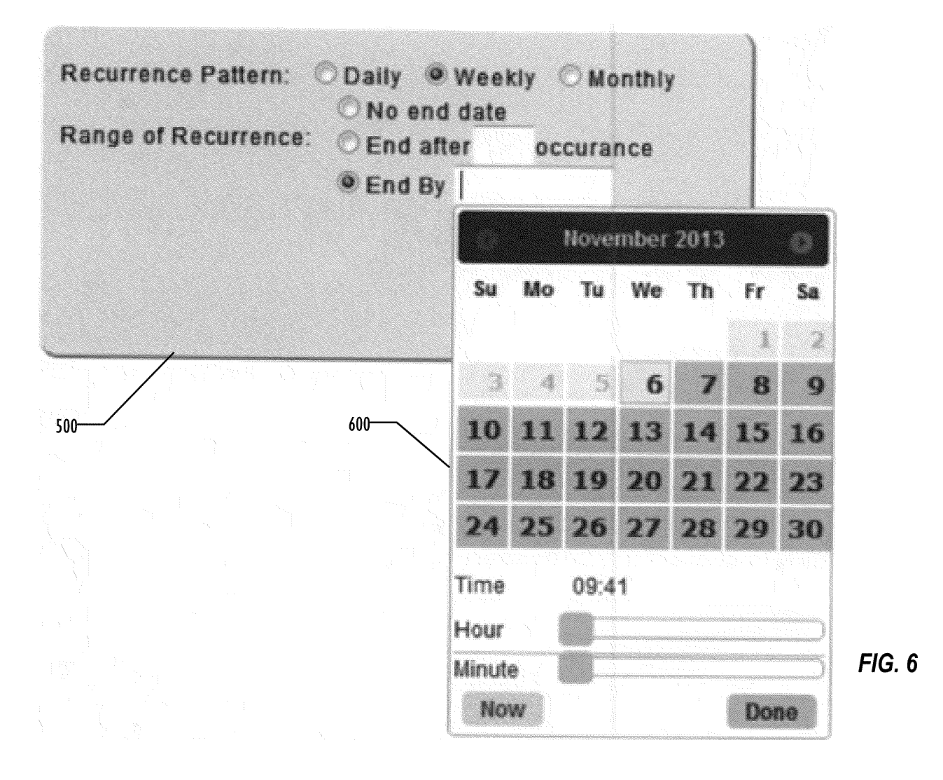

FIG. 5 is a screenshot of a user interface 500 for specifying recurrence information for a recurring launch of a guide document according to one embodiment. The specific controls illustrated in FIG. 5 are illustrative and by way of example only, and any user interface control elements for specifying recurring events may be used as desired, in any arrangement. FIG. 6 is a screenshot illustrating a technique according to one embodiment for specifying in interface control element 600 an ending date and time for the recurring launch event.

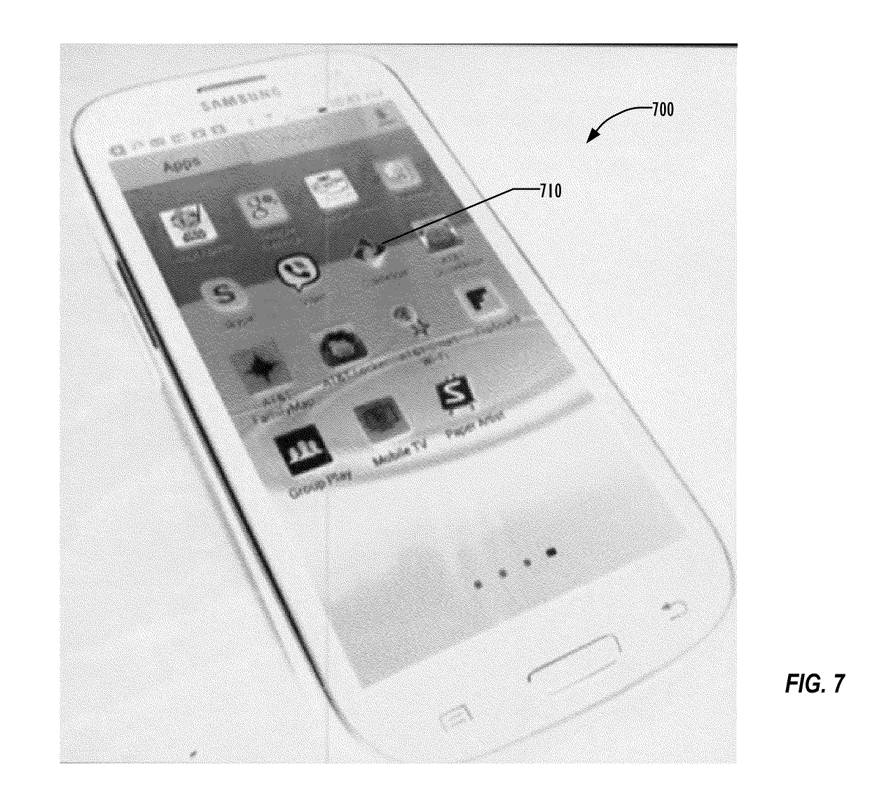

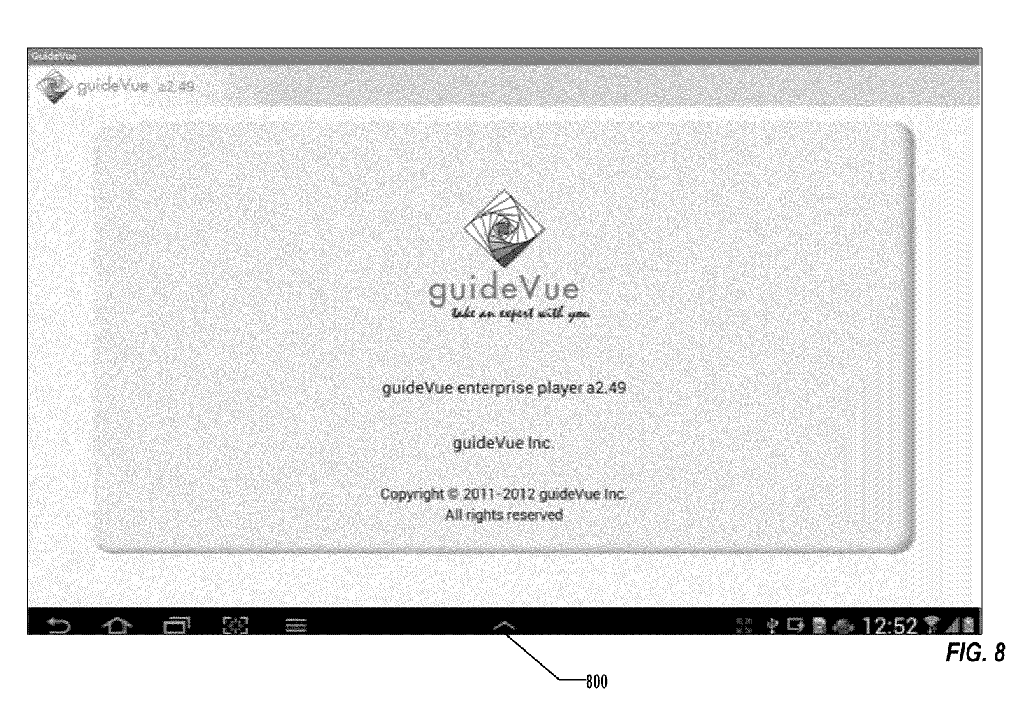

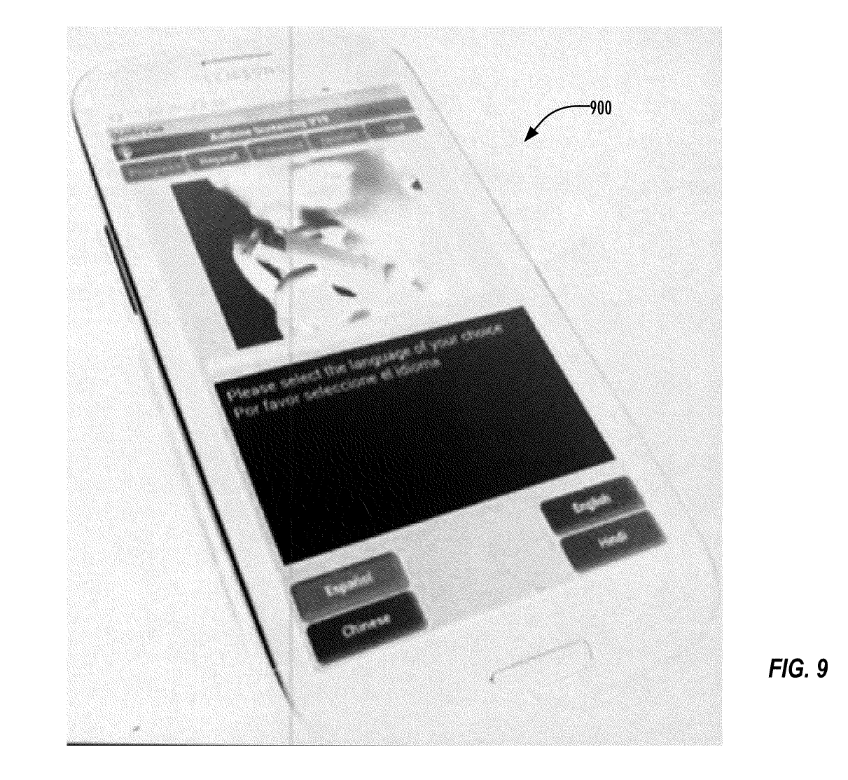

FIG. 7 is an illustration of a mobile device 700 on which an application 710 for running guided documents has been installed according to one embodiment. FIG. 8 is a screenshot 800 of an initial screen of the application. FIG. 9 is a screenshot 900 of the application in use, in this example asking the user to select a language for use in the guided document.

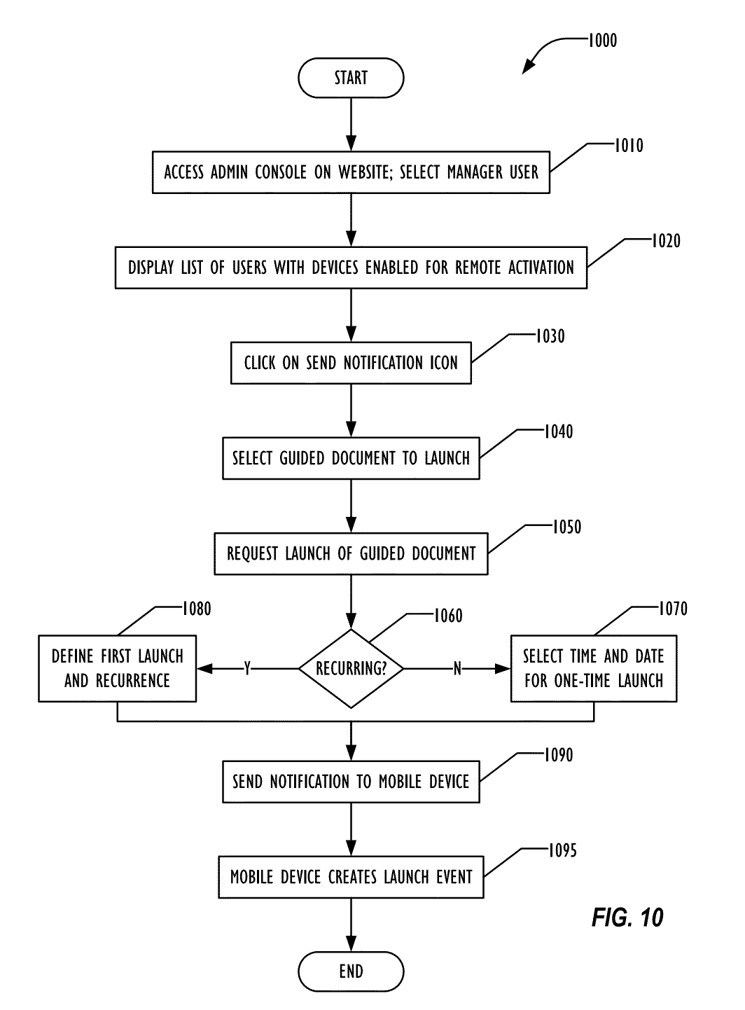

FIG. 10 is a flowchart 1000 illustrating a technique for remotely launching a guided document according to one embodiment. In block 1010, the administration tool illustrated in FIG. 1 is accessed, selecting a manager user for the scheduling technique. In block 1020, as in FIG. 2, a list of users with devices enabled for remote activation may be displayed. In block 1030 the administrative user may select a “send notification” icon or otherwise indicate a desire to schedule remote launch of a guided document. The administrative tool may be accessed via a central website provided by the remote server.

In block 1040, the administrative user may select which document to launch, then request launch in block 1050. In some embodiments, the selection is made by displaying a list of guided documents, such as in a pull-down menu. The administrative user may then select one of the guided documents from the list. As illustrated in FIG. 3, the user may request an immediate launch of the guided document or a scheduled launch. If a scheduled launch is selected, then in block 1060 an indication is made whether the launch should be recurring or one time only, using a user interface control such as control 410. If a recurring launch is selected, then recurrence parameters may be selected, such as the date and time of the first launch and other recurrence parameters, using user interface controls such as are illustrated in FIGS. 5-6. Some embodiments may provide for only one-time launches and other embodiments may provide for only recurring launches, but the capability to do both is preferred.

If a one-time launch is selected, then the timing of the launch may be specified in block 1070, such as by the user interface controls of FIG. 4. In some embodiments, these controls are used for specifying the timing of a one-time launch as well as the timing of a recurring launch. In other embodiments, separate user interface elements may be provided for each type of remote launch.

Other parameters may be provided for scheduling the remote launch of the guided document. For example, in one embodiment, geofencing may be used to cause launch of the application to display the desired guided document based on the location of the mobile device. The scheduling information may then be stored on the remote server or using any storage accessible to the remote server. In one embodiment, information about the schedule for launching the application and guided document on the mobile device is maintained in a database on or accessible to the remote system, such as an Structured Query Language (SQL) database, although other database or storage techniques may be used.

In block 1090, a launch event occurs that has previously been specified as described above. At that time, a remote server controlling the remote launch sends a launch instruction to the mobile device, instructing an application or service running on the mobile device to launch the guided document. These instructions may be delivered using any desired technique, typically transmitting the instructions via one or more interconnected networks connecting the remote server and the mobile device, where any of the networks may be wired or wireless. Upon receipt of the instructions, in block 1095, the mobile device may launch the guided document using the application or service receiving the instructions. At that point, the user may work through the guided document as if the user had chosen to launch the guided document.

In some embodiments, the instructions may transmit scheduling information for launching the remote document, which may then be used by the mobile device to launch the guided document at the scheduled time and date (or other parameters). In such an embodiment, the launch may not occur immediately upon receipt of the instructions, which are sent upon establishment of the schedule, but may occur upon the scheduled event. In some embodiments, the mobile device uses local scheduling resources provided by the mobile device operating system to schedule the desired launches based on the notifications received from the remote system.

In some embodiments, the launch of the guided document may be delayed responsive to usage of the mobile device at the time scheduled for the launch. For example, launching a guided document while a user is using the mobile device for a telephone call may be undesirable, and the launch may be delayed or suspended until the call is terminated. Other examples of delaying the launch may include delaying the launch for a fixed time period or until another condition occurs on the mobile device, such as Do Not Disturb period expiring.

In some embodiments, the application installed on the mobile device may also allow for local scheduling of launches of the guided document. This may be useful for mobile devices that may not have reliable network connectivity at the desired times or for other reasons. In such an embodiment, a local schedule may supersede launch instructions received from the remote server, or may provide for additional launches based on the local schedule.

In one embodiment, the launch instructions transmitted to the mobile device regarding the desired launch are implemented as an eXtended Markup Language (XML) message. In one embodiment, in addition to launching a guided document, the remote system may remotely instruct the mobile device to delete a guided document from the mobile device, or to update or load a guided document onto the mobile device, obtaining the new or updated guided document from the remote system.

In one embodiment, all executions of the application are logged, providing a recording of the launching of the application from the remote system.

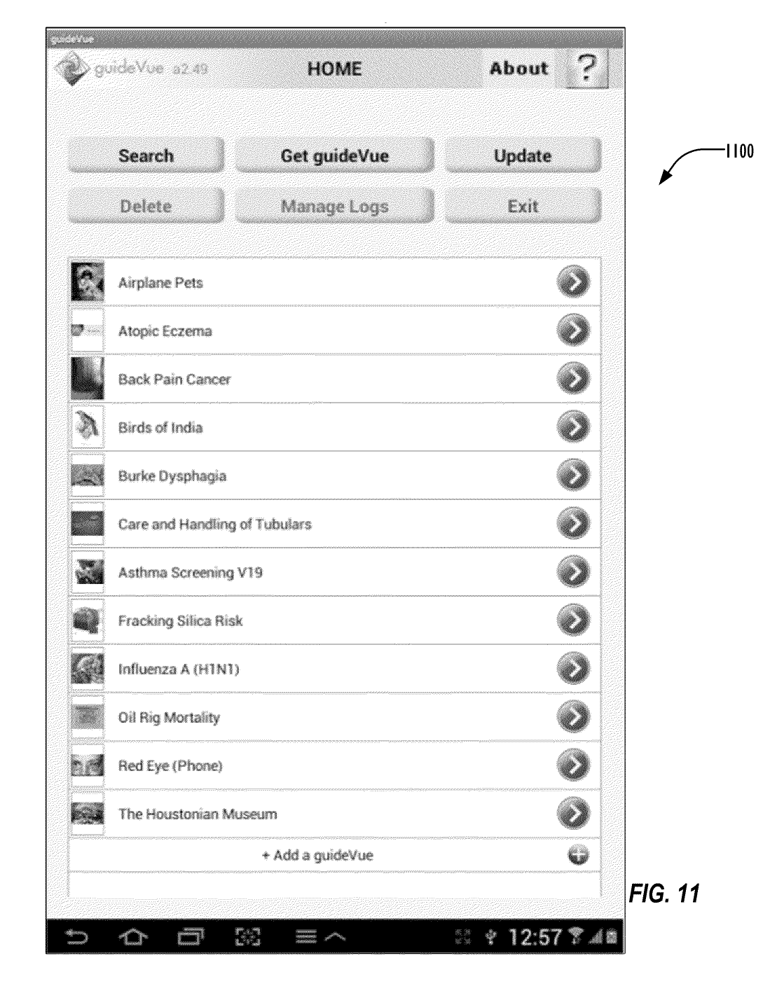

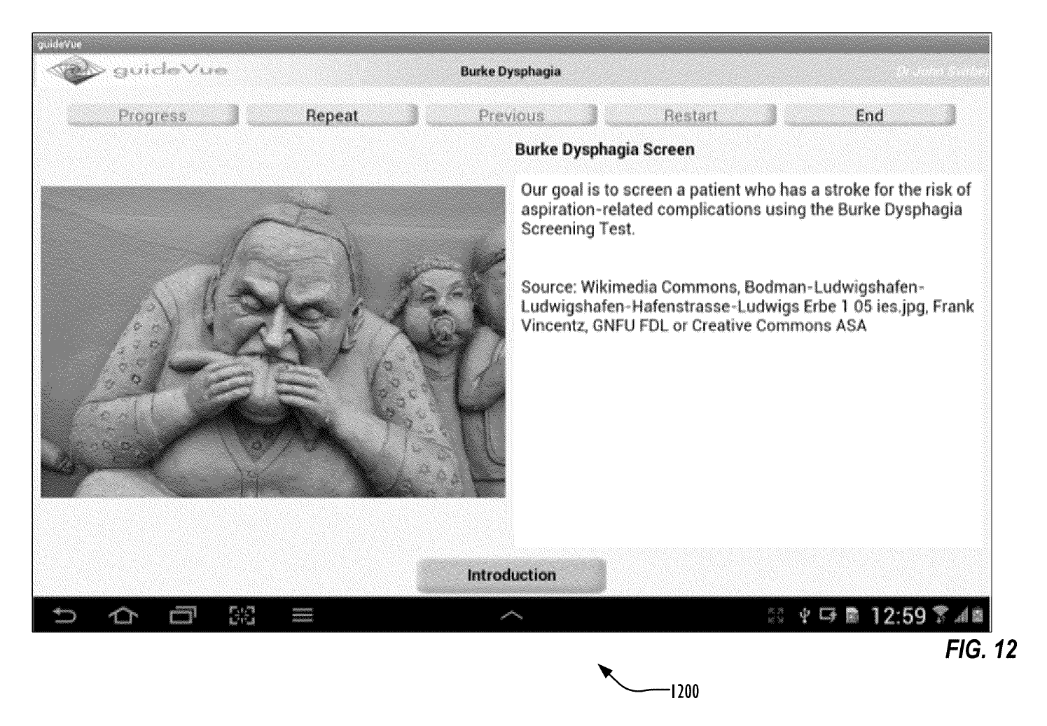

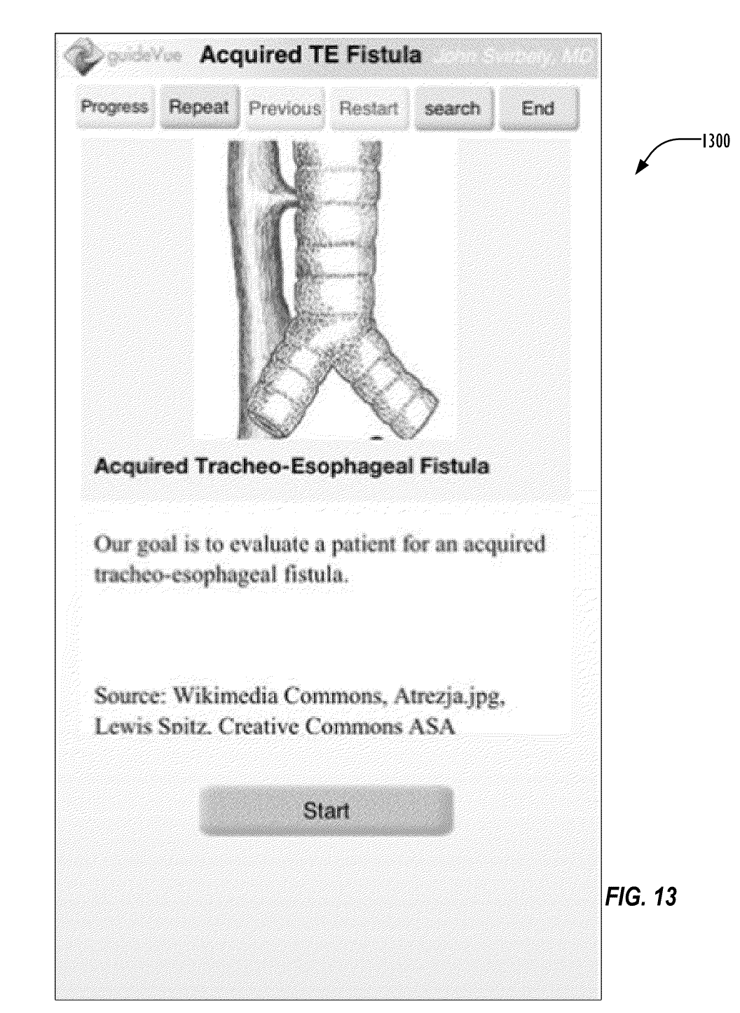

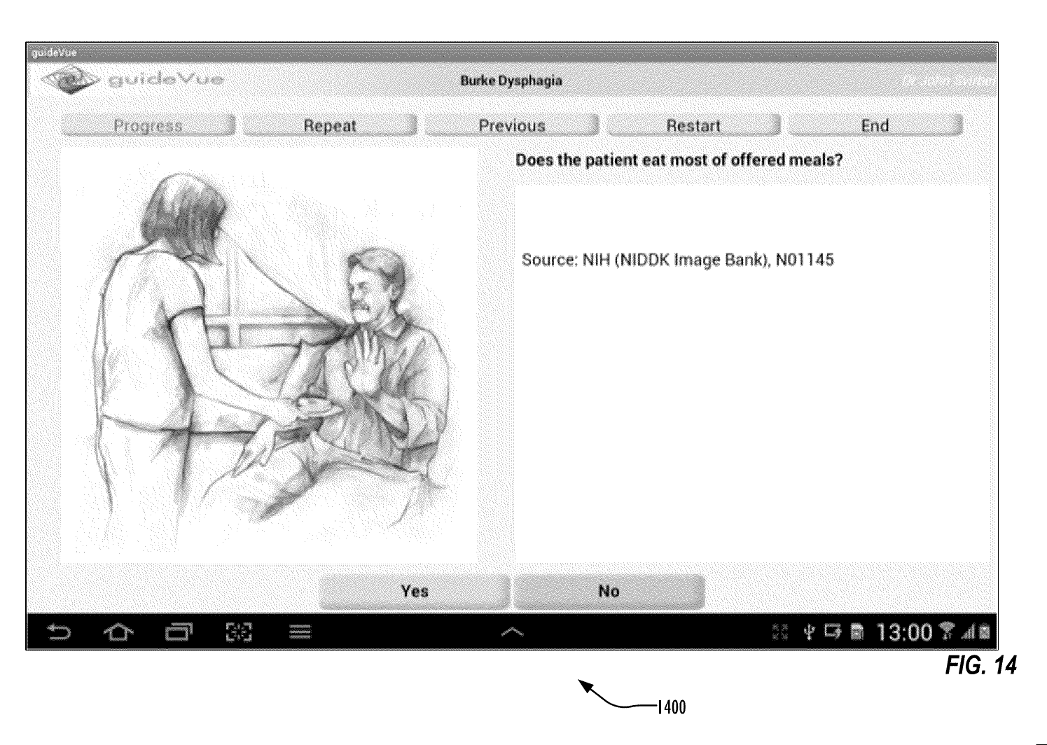

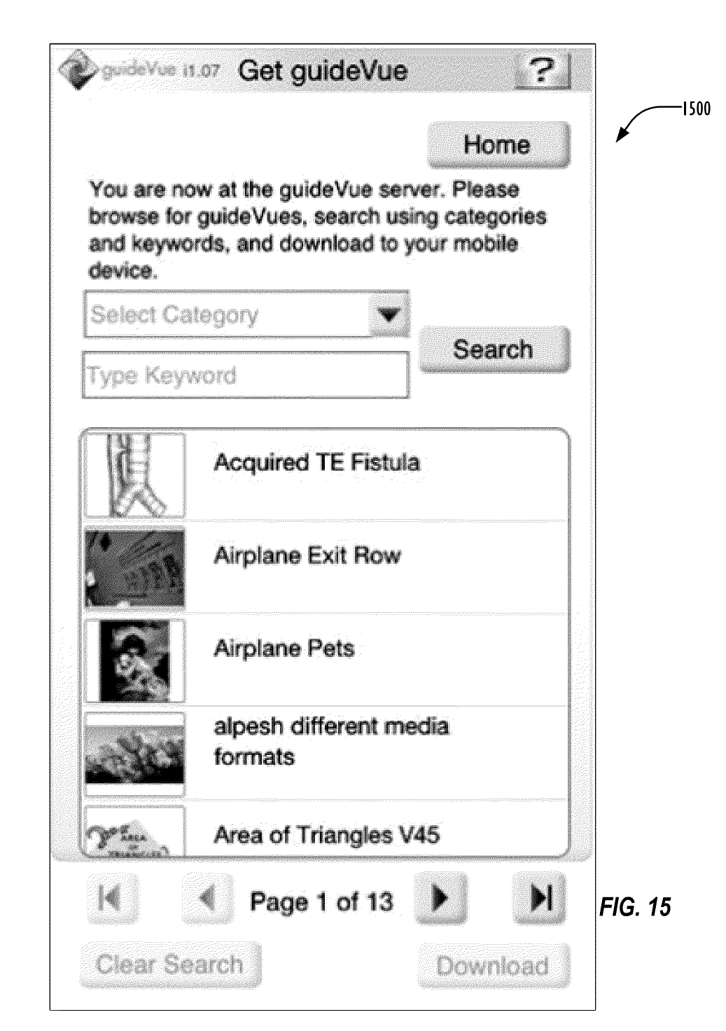

FIG. 11 is a screenshot 1100 of a mobile device application for accessing guided documents, illustrating a user interface for allowing a user manual selection of guided documents, in addition to the remote launch capabilities described above. FIGS. 12-13 are example screens of example guided documents 1200 and 1300, which illustrate the ability to navigate within the guided document. By answering questions such as provided in screen 1400 of FIG. 14, the user may be guided to make decisions.

FIG. 14 is a screen 1400 of the mobile device application illustrating a capability to obtain guided documents from a remote server, which may be the same server providing the administrative remote scheduling capability or a different server, as desired.

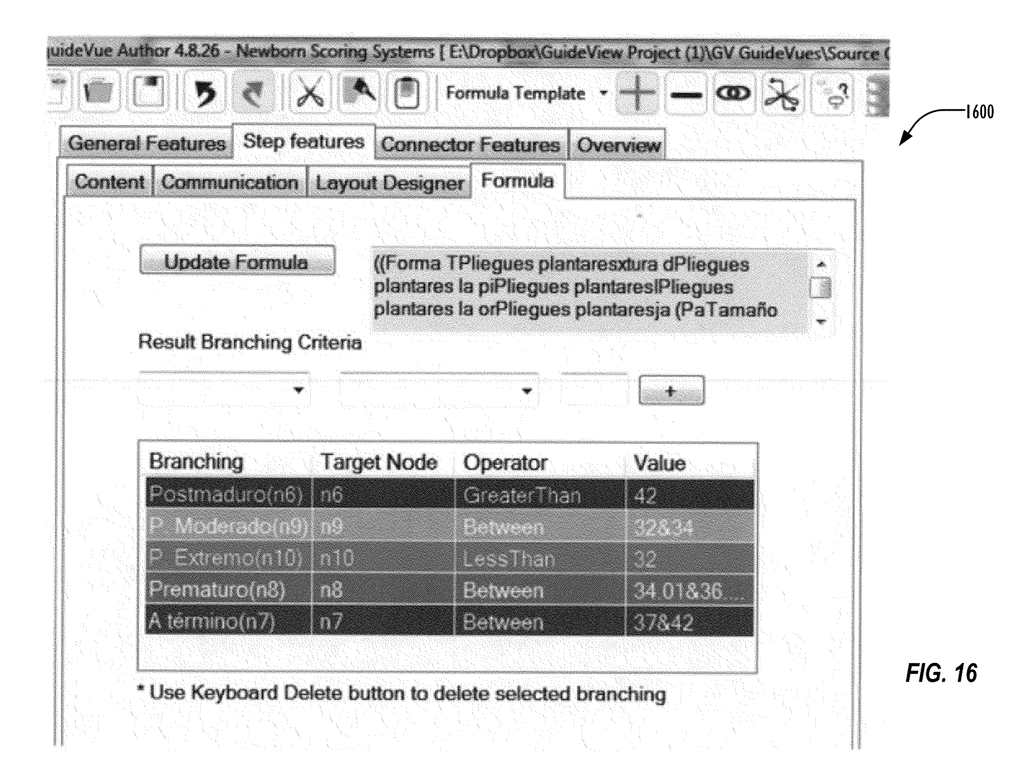

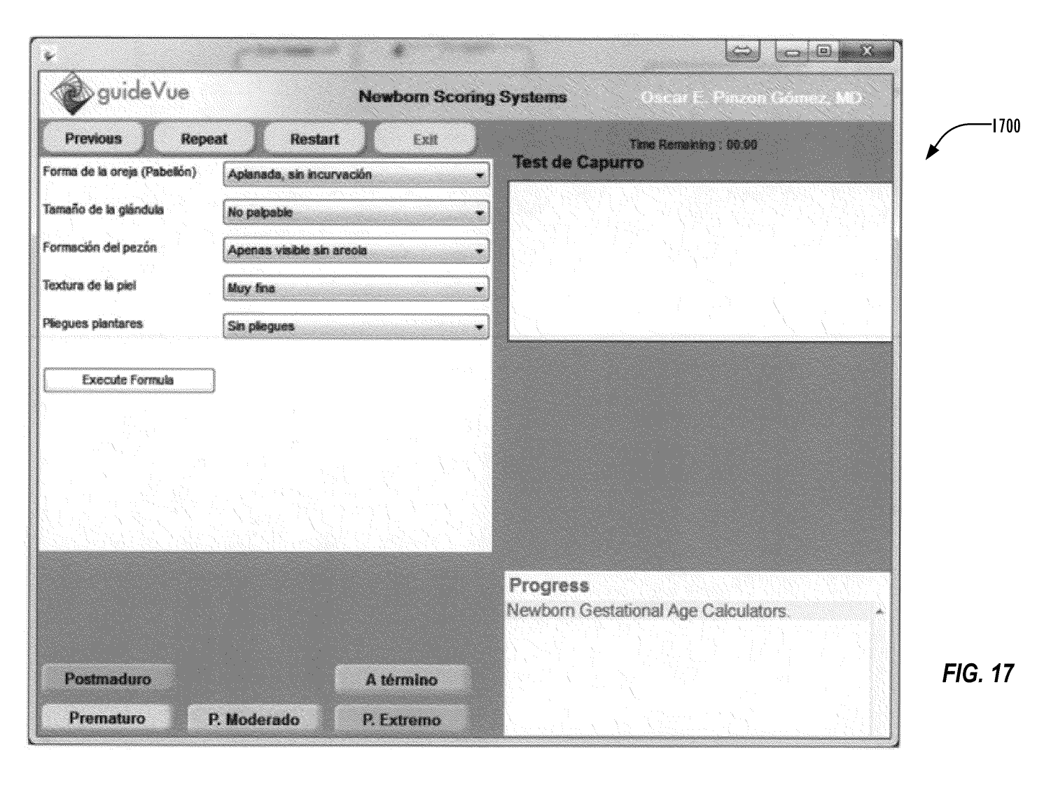

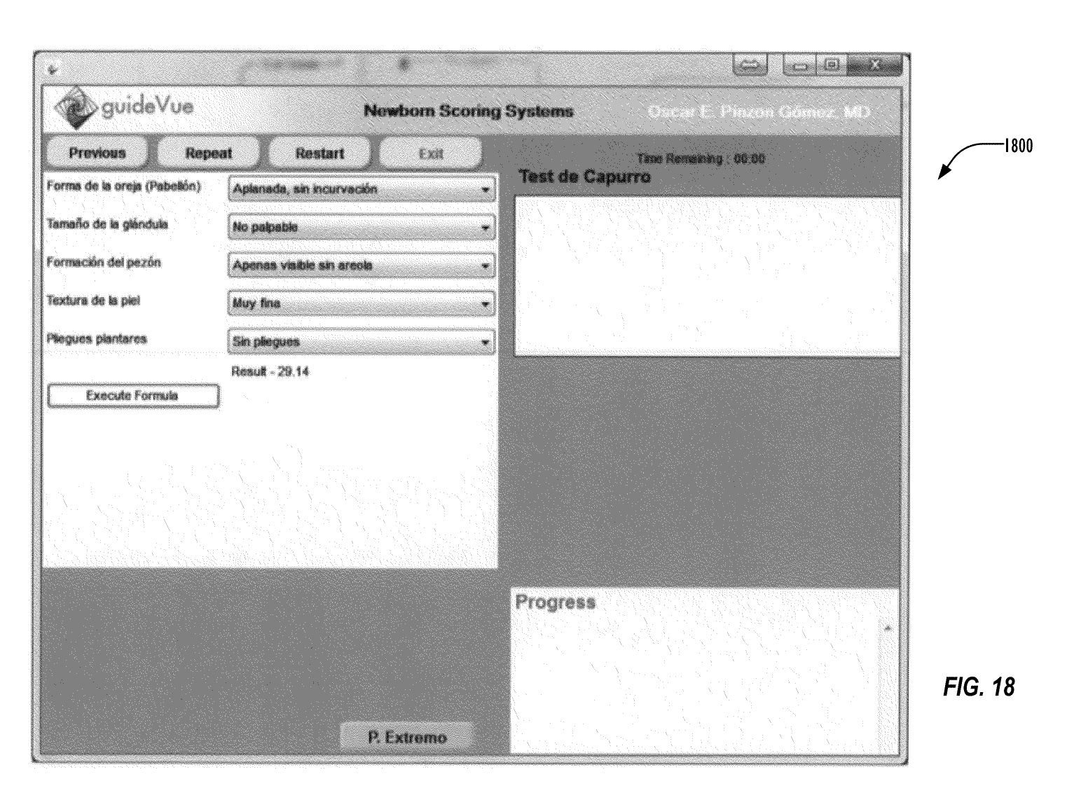

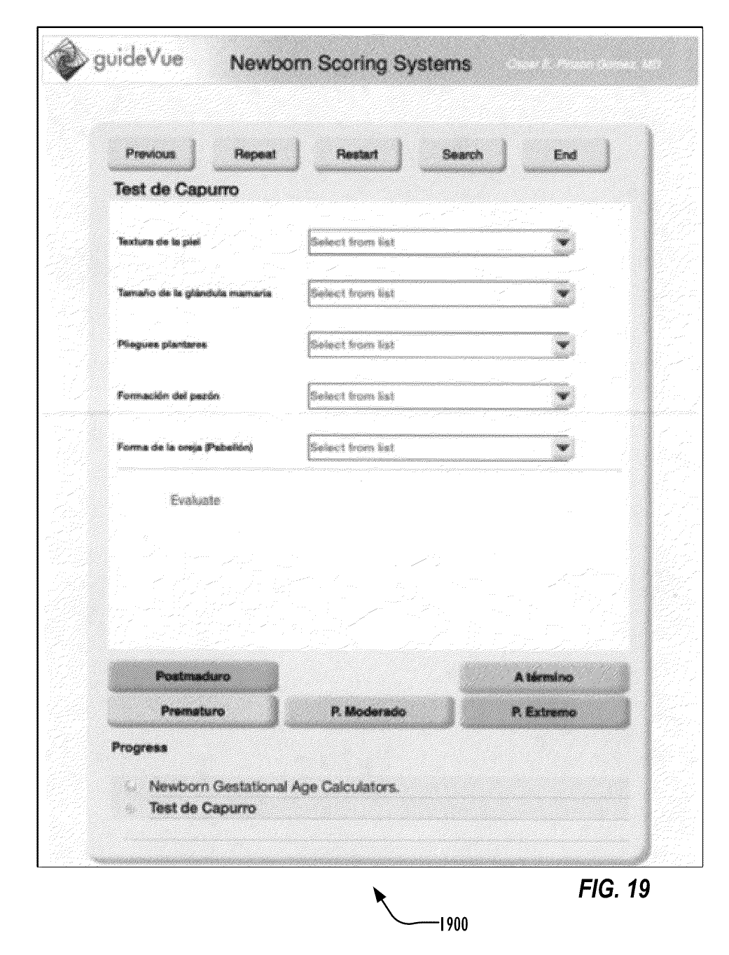

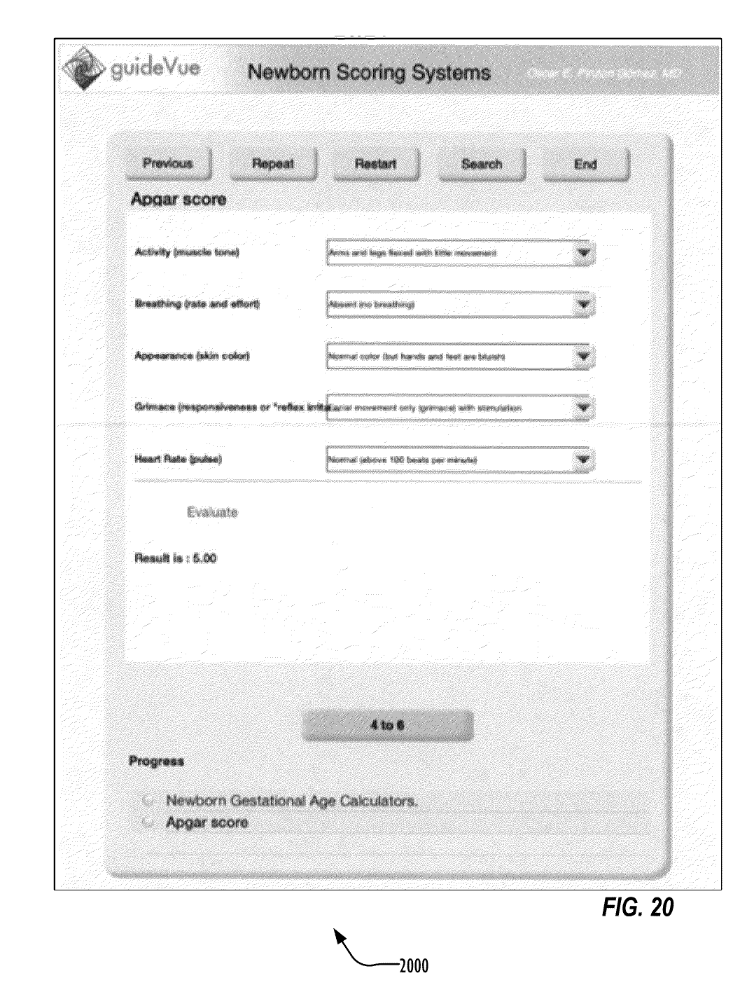

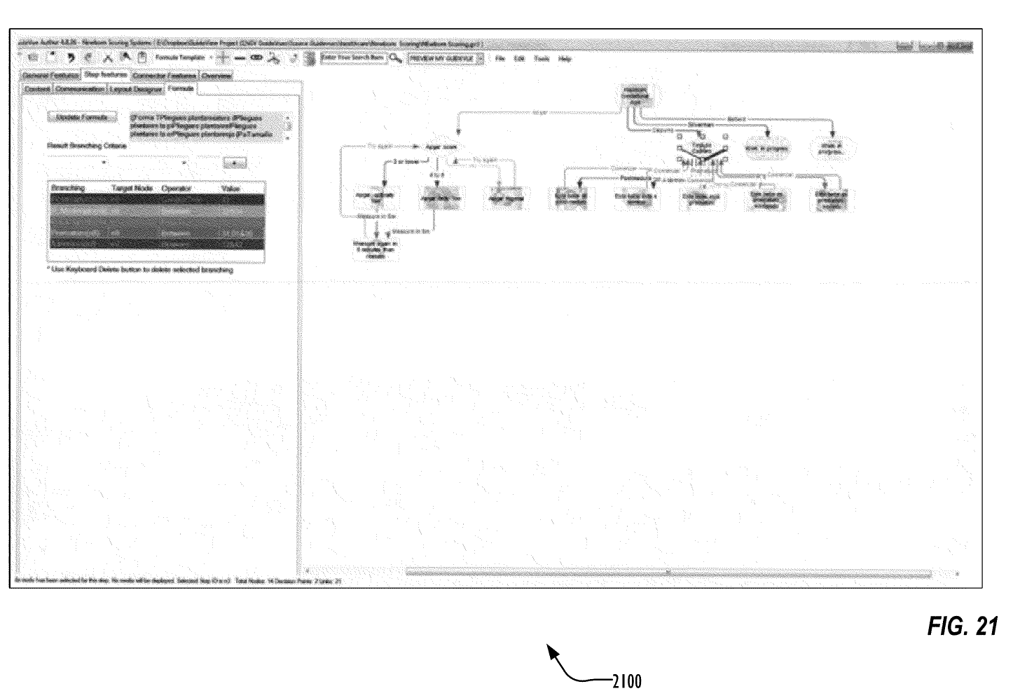

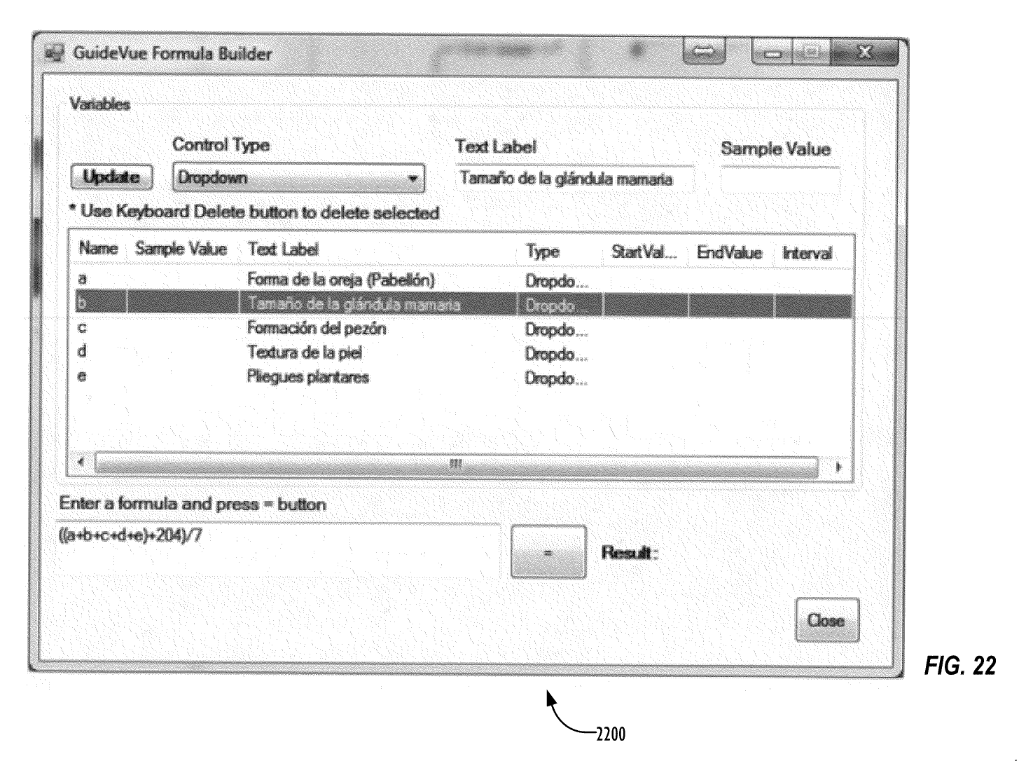

The guided documents may contain complex formulae for controlling navigation and other aspects of the guide document. For example, as illustrated in screens 1600,1700, and 1800 of FIGS. 16-18, formulas may determine a next screen to be viewed depending on one or more values of variables. These formulae may be developed by a guide document developer without the use of traditional programming languages. A user of such a guided document may see a screen such as screen 1900 of FIG. 19, allowing input of variables for use in calculating the formula. As illustrated in screen 2000 of FIG. 20, the result of the formula may be displayed in the user interface of the guided document. In some embodiments, illustrated in screen 2100 of FIG. 21, a visual development interface may be used to link the various screens of the guided document in the proper order. A formula builder tool, such as illustrated in screen 2200 of FIG. 22 may be available for easy construction of the formulae.

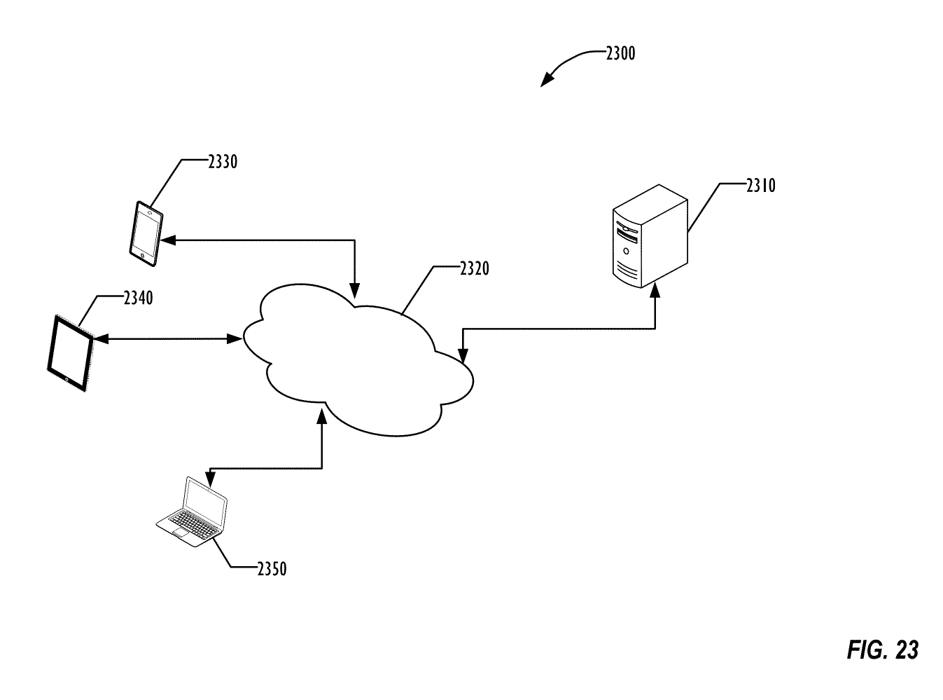

FIG. 23 is a block diagram illustrating a system 2300 according to one embodiment. In this example, mobile devices 2330 (a smart phone), 2340 (a tablet), and 2350 (a laptop computer) are connected via network 2320 to remote server 2310. Remote launch instructions are created and stored on the remote server as described above and communicated via the network to the mobile devices for the actual launching of the guided documents. The illustrated mobile devices are illustrative and by way of example only. In addition, although mobile devices are the most typical devices for launching guided documents, other programmable devices, including desktop computers, can be used as desired. The remote server 2310 may provide a web-based interface to the administrative tool for scheduling launches as well as for providing access for obtaining and updating guided documents.

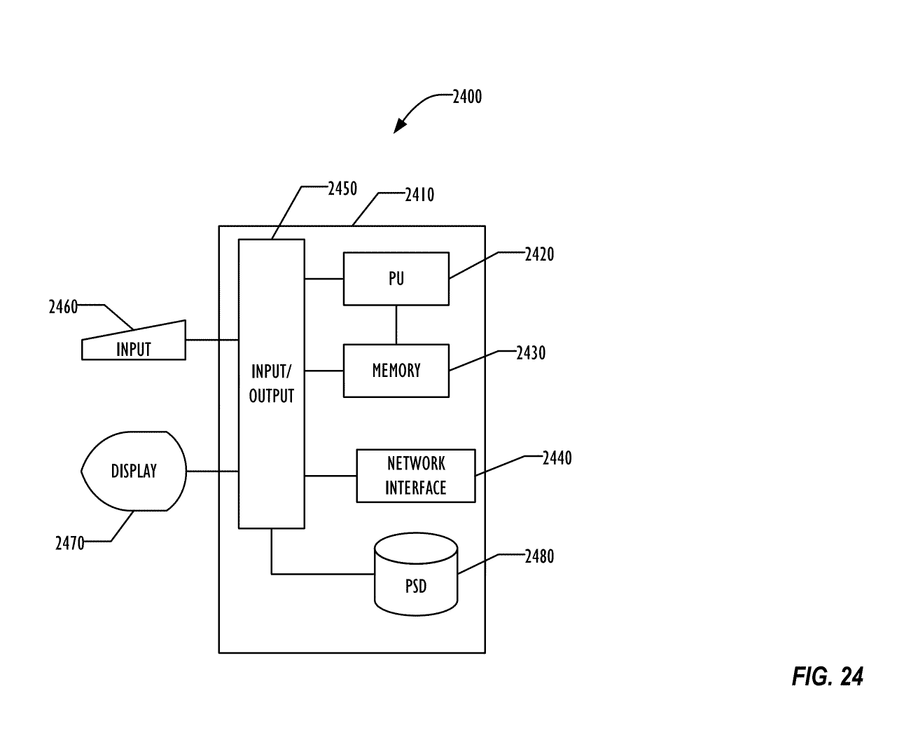

FIG. 24 is a block diagram of a programmable device 2400 that may server as the remote server 2100 or one of the mobile devices 2330-2350. A system unit 2410 contains one or more processors 2420 for executing software applications and instructions contained in those applications. Any desired type of processor may be used, including embedded processors and multi-core or multi-chip processors. A memory 2430 connected to the processor 2420 provides storage for instructions that when executed cause the processor 2420 to perform the functionality described above. A network interface 2440 provides an interface for communication with the network or networks 2320. An input/output system 2450 is connected to the processor 2420 and the memory 2430, and provides input and output functionality for the programmable device 2400, such as controlling input device(s) 2460 and display device(s) 2470. A storage device 2480 may provide storage for one or more of data used by the guided documents or software applications, as well as providing a machine readable medium for storing the instructions to be executed by the programmable device 2400. The storage device 2480 may be of any desired type, including, without limitation, hard drives, solid-state drives, and optical drives, and may support fixed or removable media. Although only a single element of each type is illustrated in FIG. 24, any number of any of the elements may be provided as desired. The elements are connected typically using links such as busses or point-to-point interconnects, but any type of interconnection functionality may be used. Any of the elements illustrated as separate elements in FIG. 24 may be combined into a single element and any of the elements illustrated in FIG. 24 may be implemented as a combination of separate elements. Other elements not illustrated in FIG. 24 may be provided, such as printers. All of the elements, including input 2460 and display 2470, may be contained within or as part of the system unit 2410, as is, for example, common in smart phones or tablets.

While certain exemplary embodiments have been described in details and shown in the accompanying drawings, it is to be understood that such embodiments are merely illustrative of and not devised without departing from the basic scope thereof, which is determined by the claims that follow.

We claim:

1. A machine readable medium on which are stored instructions, comprising instructions that when executed cause a programmable device to:
establish on the programmable device a launch schedule for a mobile device application; and
send a launch notification from the programmable device to a mobile device designated in the launch schedule upon an event defined by the launch schedule,
wherein the launch notification identifies a guided document to be used by the application on the mobile device when launched.

2. The machine readable medium of claim 1, wherein the launch schedule specifies an immediate launch event.

3. The machine readable medium of claim 1, wherein the instructions that when executed cause the programmable device to establish on the programmable device a launch schedule for a mobile device application further comprise instructions that when executed cause the programmable device to:
establish a launch schedule corresponding to a plurality of mobile devices.

4. The machine readable medium of claim 1, wherein the launch schedule specifies a recurrent event.

5. The machine readable medium of claim 1, wherein an event defined by the launch schedule specifies an operating system of the mobile device.

6. A machine readable medium on which are stored instructions, comprising instructions that when executed cause a programmable device to:
receive a launch notification instruction from a remote scheduler; and
open a guided document specified in the launch notification instruction in an application installed on the programmable device.

7. The machine readable medium of claim 6, wherein the instructions further comprise instructions that when executed cause the programmable device to:
delay opening of the guided document responsive to usage of the programmable device when the launch notification is received.

8. The machine readable medium of claim 6, wherein the instructions further comprise instructions that when executed cause the programmable device to:
receive a launch schedule via a user interface; and
open the guided document upon an event defined by the launch schedule.

9. The machine readable medium of claim 8, wherein the event defined by the launch schedule identifies a lack of connectivity with a remote server as a condition of the event.

10. A method of launching an application remotely on a mobile device, comprising:
establishing a launch schedule on a remote computer system;
sending a launch notification instruction from the remote computer system to the mobile device; and
launching a guided document in the application on the mobile device responsive to the launch notification instruction.

11. The method of claim 10, further comprising:
delaying launching of the guide document responsive to usage of the mobile device upon receipt of the launch notification instruction.

12. The method of claim 10, further comprising:
establishing a second launch schedule on the mobile device; and
launching the guide document in the application on the mobile device responsive to an event of the second launch schedule.

13. The method of claim 12, wherein the event of the second launch schedule identifies lack of connectivity to the remote computer system as a condition.

14. The method of claim 10, wherein the launch schedule defines events for a plurality of mobile devices.

15. A system for scheduling launch of a mobile device application, comprising:
a server, comprising:
a processor;
a memory, coupled to the processor, on which are stored instructions that when executed cause the processor to:
receive a launch schedule via a user interface;
store the launch schedule; and
send a launch notification instruction to a mobile device upon an event defined by the launch schedule,
wherein the launch notification instruction identifies a guided document to be opened on the mobile device; and
software for execution by a mobile device, comprising instructions that when executed cause the mobile device to:
receive the launch notification instruction; and
open the guided document identified by the launch notification instruction.

16. The system of claim 15, wherein the launch schedule specifies an immediate launch event.

17. The system of claim 15, wherein the launch schedule specifies a recurring event.

18. The system of claim 15, wherein the launch schedule identifies an operating system of the mobile device.

19. The system of claim 15, wherein the software for execution by the mobile device further comprises instructions that when executed cause the mobile device to:
delay opening the guided document responsive to usage of the mobile device when the launch notification instruction is received.

20. The system of claim 15, wherein the software for execution by the mobile device further comprises instructions that when executed cause the mobile device to:
receive a second launch schedule via a user interface on the mobile device;
store the second launch schedule on the mobile device; and
open the guided document responsive to an event defined by the second launch schedule.
